(19) United States
(12) Patent Application Publication
(10) Pub. No.: US 2024/0209525 A1
(43) Pub. Date: Jun. 27, 2024

(54) SYSTEMS AND METHODS FOR THE MANUFACTURE AND USE OF HYDROGEN

(71) Applicant: Erthos IP LLC, Tempe, AZ (US)

(72) Inventor: James S Tyler, Tempe, AZ (US)

(73) Assignee: Erthos IP LLC, Tempe, AZ (US)

(21) Appl. No.: 18/192,168

(22) Filed: Mar. 29, 2023

Related U.S. Application Data
(63) Continuation-in-part of application No. 17/820,222, filed on Aug. 16, 2022, now abandoned.
(60) Provisional application No. 63/387,543, filed on Dec. 15, 2022.

(51) Int. Cl. C25B 9/65; C25B 9/70; C25B 15/08; F01K 11/00; H02S 10/10; H02S 40/36

(52) U.S. Cl. CPC C25B 9/65; C25B 9/70; C25B 15/083; F01K 11/00; H02S 10/10; H02S 40/36

(57) ABSTRACT

Devices, systems and methods for improved hydrogen manufacture, processing, and shipping using solar derived power. A system for manufacturing hydrogen gas uses a solar power generator, an electrolyzer powered by the solar power generator, a gas separator for separating gases generated by the electrolyzer, such as oxygen and hydrogen, and a gas compressor for compressing the gases for transport and later use. The solar power generator may be one or more PV arrays and may further be at least one earth mount PV assembly. The PV assemblies may connect in parallel or in series. The electrolyzer comprises at least two distributed electrolyzer stacks. A system for manufacturing hydrogen and using the hydrogen gas may use a solar power generator, an oxyhydrogen electrolyzer powered by the solar power generator, and an oxyhydrogen boiler that generates steam for generating electrical power.

### CROSS-REFERENCE TO RELATED APPLICATIONS

This application is a continuation-in-part of what claims priority to U.S. patent application Ser. No. 17/820,222 filed Aug. 16, 2022 and entitled “Electrolyzer Systems and Methods” U.S. Pat. App. Ser. No. 63/387,543, filed Dec. 15, 2022, and which is hereby incorporated by reference in its entirety.]

### BACKGROUND

Electrolysis has shown to be a promising way to create hydrogen in a carbon free or near carbon free manner from renewable sources, such as water, potassium hydroxide (KOH) and sodium hydroxide (NaOH) solutions, and other electrolytes. Electrolysis is a process that uses electricity to split water into hydrogen and oxygen in a reaction chamber known as an electrolyzer. Electrolyzers can range in size from relatively small “table-top” size devices, to large, industrial scale “factory” sized devices. The reaction chambers or “cells” are often connected together in series to form “stacks” to increase the hydrogen and oxygen output.

A variety of electrolyzers are known in the art, generally consisting of at least one anode and at least one cathode and submerged in water or another electrolyte solution. An electric current passing through the anode and cathode causes the water to split into oxygen (anode side) and hydrogen (cathode side), either or both of which can be collected and used for a variety of purposes, including downstream power generation.

For example, the hydrogen can be used as fuel for fuel-cell electric vehicles such as automobiles, buses and other vehicles. Hydrogen can also be used to power factories, and in place of or to supplement other heating and power generating gases such as natural gas. The hydrogen can also be used as in the production of other chemicals and compositions, such as methanol, fertilizers and other fuels.

While hydrogen is often manufactured near where it is intended to be used, it is possible to distribute hydrogen through a variety of known methods, for example, by compressing the hydrogen gas in high-pressure containers and shipping the hydrogen by trucks, train, or other transport vehicles. Alternatively, the hydrogen may be transported via other means such as gas or liquid fuel pipelines.

However, though electrolysis has shown to be a promising way to create environmentally friendly hydrogen gas, there remain challenges related to production, including the manner of powering the electrolysis systems in an efficient and environmentally friendly manner and minimizing the number of steps required to generate and transport the hydrogen.

For example, FIG. 1 is a typical prior art electrolysis hydrogen manufacturing process illustrating a complex system having an electrolyzer power generator such as a DC generator 99, a DC/AC inverter 105, a transformer 110, voltage transfer components 115 and/or grid connect components 120 which provide power to a second transformer 125, a rectifier 130, an electrolyzer 135, a gas separator 140, a gas compressor 145, and a transport vehicle 150. FIG. 2 is similar to FIG. 1 but uses a solar PV array 100 to create power for the system rather than a DC generator.

These components and steps require high capital investments, may suffer from inefficiencies and losses at or between each step, and if any one or more of these components fail, the system loses operational capacity and capability. The resulting cost for manufacturing hydrogen in systems such as those illustrated in FIGS. 1 and 2 has been demonstrated to cost anywhere from US$3.30/kg and upward.

Accordingly, improved and more efficient systems and methods for hydrogen manufacture, processing, and shipping are desirable.

### SUMMARY

The present disclosure comprises devices, systems and methods for improved hydrogen manufacture, processing, and shipping using solar derived power. For example, a system for manufacturing hydrogen gas using electrolysis in accordance with the present disclosure comprises a solar power generator, an electrolyzer powered by the solar power generator, a gas separator for separating gases generated by the electrolyzer, such as oxygen and hydrogen, and a gas compressor for compressing the gases for transport and later use.

In some versions, the solar power generator comprises one or more PV arrays. In some versions, the solar power generator comprises at least one earth mount PV assembly. The various PV assemblies may connect in at parallel or in series.

In some versions, the electrolyzer comprises at least two distributed electrolyzer stacks.

In some versions, a gas transport is provided. For example, the gas transport may be a vehicle, a pipeline or other means for transporting the gas.

The present disclosure may also comprise devices, systems and methods for improved hydrogen manufacture using solar derived power and the use of the solar derived hydrogen. For example, a system for manufacturing hydrogen and using the hydrogen gas using electrolysis in accordance with the present disclosure comprises a solar power generator, an oxyhydrogen electrolyzer powered by the solar power generator, and an oxyhydrogen boiler that generates steam for generating electrical power, for example, in a factory or other industrial facility. In some versions, the oxyhydrogen electrolyzer comprises two or more distributed oxyhydrogen electrolyzer stacks.

### BRIEF DESCRIPTION OF DRAWINGS

The accompanying drawings provide a further understanding of the invention and are incorporated in and constitute a part of this specification, illustrate versions of the invention, and together with the description serve to explain the principles of the invention.

FIG. 1 is a diagram of a prior art electrolysis hydrogen manufacturing system illustrating a DC/AC power generator, a DC/AC inverter, a transformer, voltage transfer components, grid connect components, a second transformer, a rectifier, an electrolyzer, a gas separator, a gas compressor, and a transport vehicle.

FIG. 2 is a diagram of a prior art electrolysis hydrogen manufacturing system illustrating a solar power generator, a DC/AC inverter, a transformer, voltage transfer components, grid connect components, a second transformer, a rectifier, an electrolyzer, a gas separator, a gas compressor, and a transport vehicle.

FIG. 3 is a diagram of an electrolysis hydrogen manufacturing system illustrating a solar power generator, an electrolyzer, a gas separator, a gas compressor, and a transport vehicle in accordance with the present disclosure.

FIG. 4 is a diagram of an electrolysis hydrogen manufacturing system illustrating an earth mounted solar power generator, an electrolyzer, a gas separator, a gas compressor, and a transport vehicle in accordance with the present disclosure.

FIG. 5 is a diagram of an electrolysis hydrogen manufacturing system illustrating an earth mounted solar power generator, a distributed electrolyzer stack, a gas separator, a gas compressor, and a transport vehicle in accordance with the present disclosure.

FIG. 6 is a diagram of an electrolysis hydrogen manufacturing system illustrating an earth mounted solar power generator, a distributed oxyhydrogen electrolyzer stack, and an oxyhydrogen boiler located in a factory.

### DETAILED DESCRIPTION

To the extent that the material doesn't conflict with the current disclosure, this disclosure incorporates by reference the entire contents of the following Pat. App. Ser. No.: 17/153,845; 63/120,931; 63/079,778; 63/021,825; 63/052,369; 63/052,367; 62/963,300; 17/152,663; 63/021,928; 62/903,369; 16/682,503; 16/682,517; 17/079,949; 63/172,599; 17/316,647; 17/316,535; 17/336,393; 17/336,404; 17/336,407; 17/336,417; 17/336,431; 17/336,442; 17/336,699; 17/337,234; and Ser. No. 17/337,240.

Unless defined otherwise, all technical and scientific terms used in this document have the same meanings as commonly understood by one skilled in the art to which the disclosed invention pertains. Singular forms-a, an, and the-include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that implementations exist for each component and any combination of the components-including combinations that specifically exclude any one or any combination of the listed components. For example, “component A is chosen from A, B, or C” discloses implementations with A, B, C, AB, AC, BC, and ABC. It also discloses (AB but not C), (AC but not B), and (BC but not A) as implementations, for example. Combinations that one of ordinary skill in the art knows to be incompatible with each other or with the components' function in the invention are excluded, in some implementations.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. In addition, terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, and “upper,” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations), and the spatially relative descriptors interpreted.

The description of the implementations has been provided for illustration and description. It is not intended to be exhaustive or to limit the invention. Individual elements or features of a particular implementation are not limited to that implementation but, where applicable, are interchangeable and can be used in a selected implementation, even if not explicitly shown or described. The same may also be varied. Such variations are not a departure from the invention, and all such modifications are included within the invention's scope.

Persons skilled in the art will readily appreciate that various aspects of the present invention may be realized by any number of methods and apparatuses configured to perform the intended functions. Stated differently, other methods and apparatuses may be incorporated herein to perform the intended functions. It should also be noted that the accompanying drawing figures referred to herein are not all drawn to scale but may be exaggerated to illustrate various aspects of the present invention, and in that regard, the drawing figures should not be construed as limiting. Finally, although the present invention may be described in connection with various principles and beliefs, the present invention should not be bound by theory.

The above being noted, the present disclosure contemplates improved hydrogen manufacture, processing, and shipping using solar derived power. For example, a system for manufacturing hydrogen gas using electrolysis in accordance with the present disclosure comprises a solar power generator, an electrolyzer powered by the solar power generator, a gas separator for separating gases generated by the electrolyzer, such as oxygen and hydrogen, and a gas compressor for compressing the gases for transport and later use.

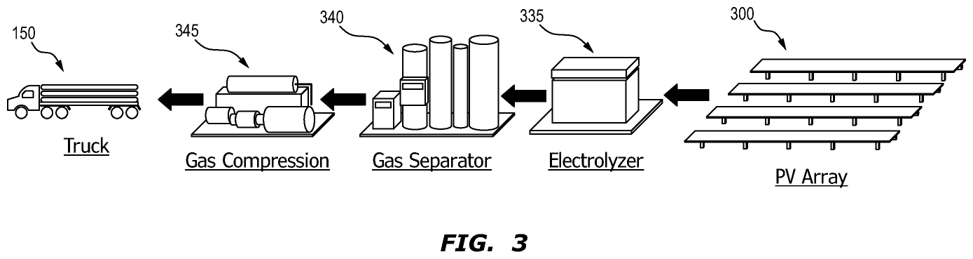

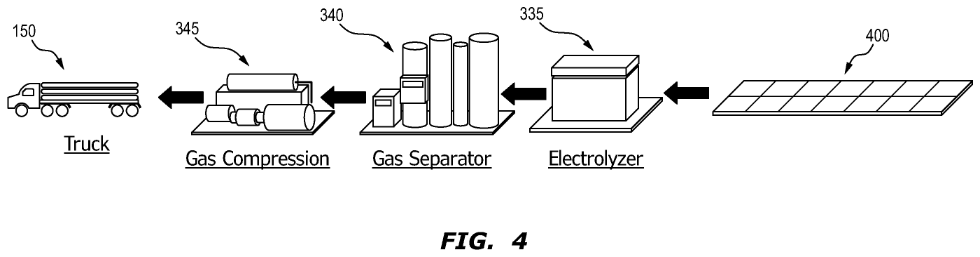

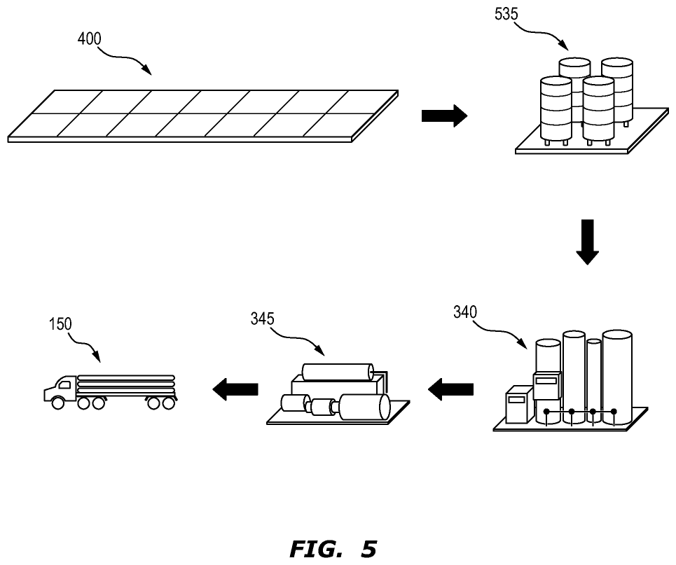

In an embodiment and with reference to FIG. 3, the solar power generator comprises one or more PV arrays 300, which may comprise fixed tilt systems, single axis tracker systems, or the like, though in other versions such as those disclosed in FIGS. 4-5, the solar power generator may comprise one or more earth mount PV assemblies 400. Non-limiting examples of earth mount PV assemblies 400 are described in U.S. Pat. No. 10,826,426, issued Nov. 3, 2020 and entitled “Earth Mount Utility Scale Photovoltaic Array with Edge Portions Resting on Ground Support Area,” which is hereby incorporated by reference in its entirety. The solar power generator 300, 400 may be connected in series or in parallel and produce DC power to the electrolyzer(s) 335, 535. In various alternative versions, the solar power generator may be any now known or as yet unknown solar power generating devices.

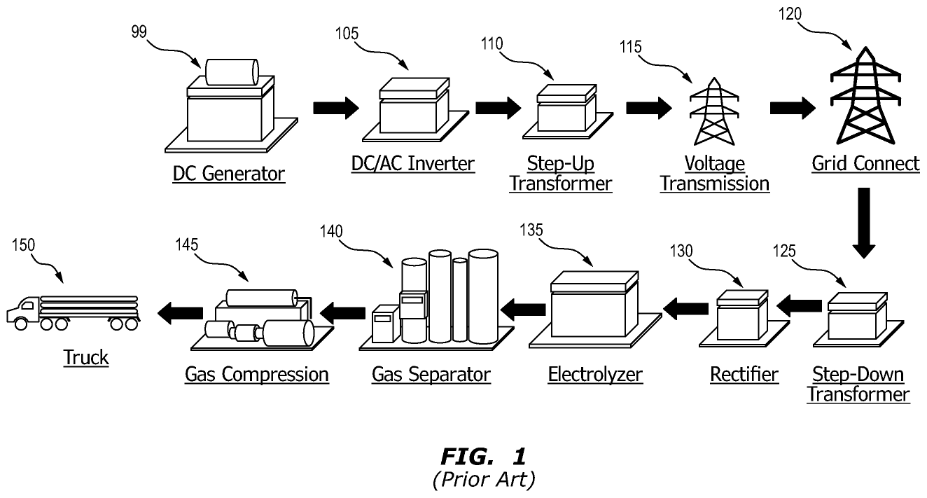

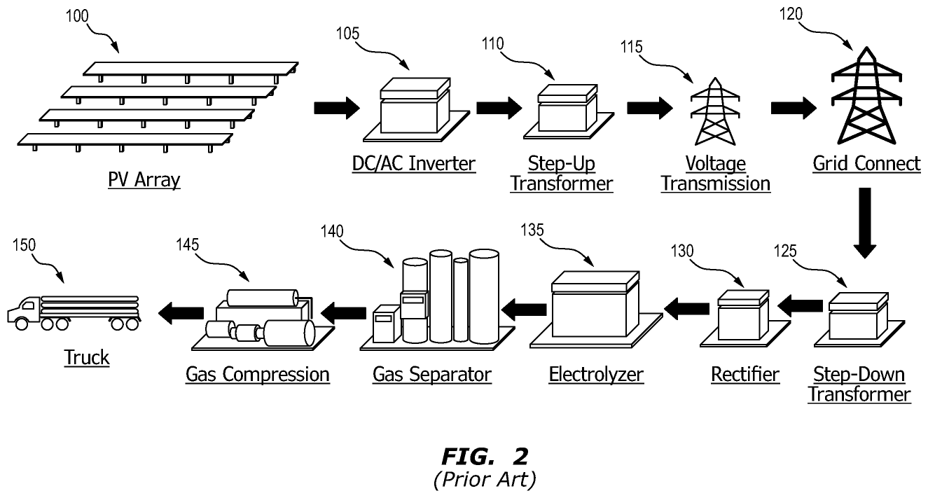

In versions in accordance with the present disclosure, as illustrated in FIGS. 3-5 and in contrast to the systems illustrated in FIGS. 1 and 2, the solar power generator 300, 400 provides power to the electrolyzer 335, 535 to perform the electrolysis with minimal infrastructure between the solar power generator 300, 400 and the electrolyzer 335, 535, and in some cases, the solar power generator 300, 400 provides power directly to the electrolyzer 335, 535 with no intervening components.

For example, with momentary reference back to FIGS. 1 and 2, components such as the DC/AC inverter 105, the transformer 110, voltage transfer components 115 and grid connect components 120, which provide power to the second transformer 125, and the rectifier 130 may all be eliminated. Because these components and steps require high capital investments, their elimination likewise removes potential inefficiencies and losses that occur through inherent limitations and/or failure of any one of these components. Thus, the resulting cost per kilogram of hydrogen for manufacturing hydrogen in the improved systems such as those illustrated in FIGS. 3-5 is substantially reduced. For example, a system such as illustrated in FIG. 5 may result in a cost per kilogram of hydrogen of US$1.30/kg or less.

In accordance with the present disclosure, the electrolyzer 335, 535 may comprise any now known or as yet unknown electrolysis devices. For example, electrolyzer 335, 535 may comprise designs, methods and systems such as those disclosed in U.S. patent application Ser. No. 17/820,222 filed Aug. 16, 2022 and entitled “Electrolyzer Systems and Methods” which is hereby incorporated by reference in its entirety.

In accordance with the present disclosure, devices, systems and methods for improved hydrogen manufacture may comprise two or more distributed electrolyzer stacks.

In accordance with the present disclosure, the solar power generator 300, 400 are connected directly to the electrolysis stack. These stacks include a positive and negative electrode positioned in an electrolytic medium (or fluid), such as water. In some versions, the electrolytic medium includes potassium hydroxide (KOH), sodium hydroxide (NaOH), or other electrolytes or salt, increasing the number of dissolved ions, thereby increasing electrical conductivity.

Because of the power generated by the solar power generators 300, 400 may vary based on factors such as weather, time of day or year, and other factors, an electrolyzer stack in accordance with the present disclosure may have an aggregate resistance (R) adjusted to match the maximum power point of the DC power source (i.e., the solar generator) through one or more mechanisms, including but not limited to changing or adjusting:
the depth of one or both of the negative or positive electrodes in the electrolytic fluid;
the fluid level (e.g., the fluid height relative to one or more electrodes);
the fluid temperature;
the distance between the positive and negative electrodes;
the number of electrode cells in series;
the number of electrode panels in parallel;
the fluid volume;
the surface area of the electrodes exposed to the electrolyte; and
the stack resistance using other methods, now known or as yet unknown.

In one embodiment, the resistance is changed automatically by a controller (or control system) based on changes in the input voltage.

In accordance with versions of the present disclosure, devices, systems and methods for improved hydrogen manufacture may comprise a gas transport for transporting gas separated by the system. For example, the gas transport may be a vehicle 150 such as truck, train, or watercraft (e.g., a ship or marine vessel), a gas or liquid pipeline or other means for transporting the gas.

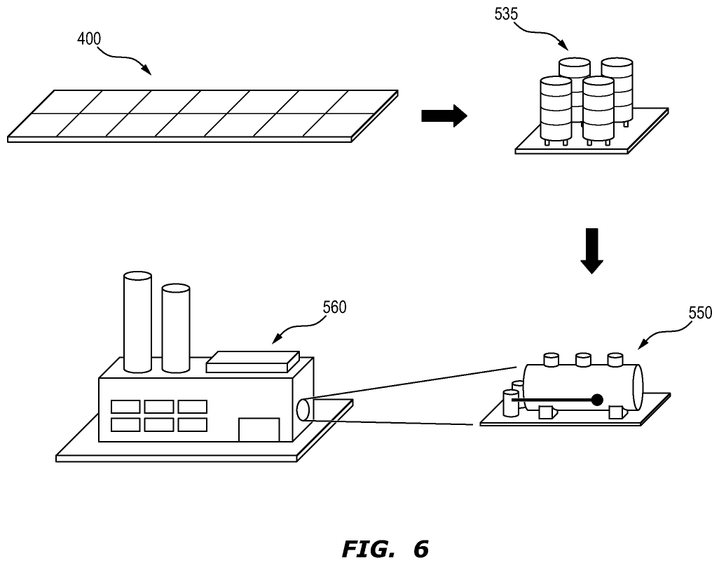

Versions in accordance with the present disclosure may also comprise devices, systems and methods for improved oxyhydrogen manufacture using solar derived power and the use of the resulting solar derived oxyhydrogen. For example, a system for manufacturing hydrogen and using the hydrogen gas using electrolysis in accordance with the present disclosure comprises a solar power generator, an oxyhydrogen electrolyzer powered by the solar power generator to generate oxyhydrogen gas, and an oxyhydrogen boiler that generates steam for generating electrical power using the oxyhydrogen gas. With reference to FIG. 6, in some versions, the oxyhydrogen electrolyzer comprises two or more distributed electrolyzer stacks 535.

In an embodiment and with continuing reference to FIG. 6, the solar power generator 400 comprises various known PV arrays or assemblies, such as, for example, one or more earth mount PV assemblies 200 similar to those described in connection with FIGS. 4-5 above and as described in U.S. Pat. No. 10,826,426, issued Nov. 3, 2020 and entitled “Earth Mount Utility Scale Photovoltaic Array with Edge Portions Resting on Ground Support Area.” The solar power generator 400 may be arrays or assemblies may connect in at parallel or in series. In various alternative versions, the solar power generator may be any now known or as yet unknown solar power generating devices.

In versions in accordance with the present disclosure, as illustrated in FIG. 6 and again in contrast to the systems illustrated in FIGS. 1 and 2, the solar power generator 400 provides power to distributed electrolyzers 535 to perform electrolysis producing oxyhydrogen gas, with minimal infrastructure between the solar power generator 400 and the electrolyzers 535, and in some cases, the solar power generator 400 provides power directly to the electrolyzers 535, with no intervening components.

Again, by eliminating components such as those illustrated in FIGS. 1 and 2, including the DC/AC inverter 105, the transformer 110, voltage transfer components 115 and grid connect components 120, which provide power to the second transformer 125, and the rectifier 130, potential inefficiencies and losses that occur through inherent limitations and/or failure of any one of these components are similarly eliminated. The resulting cost per kilogram of hydrogen for manufacturing hydrogen or oxyhydrogen in the improved systems such as those illustrated in FIG. 6 is substantially reduced. For example, a system such as illustrated in FIG. 6 may result in a cost per kilogram of hydrogen of US$1.13/kg or less.

In accordance with the present disclosure and with continuing reference to FIG. 6, solar power generators 300, 400 such as PV assemblies, PV panels, or a combination of PV assemblies or panels may be connected in series or in parallel and produce DC power to the electrolyzer(s) 535.

In accordance with the present disclosure, the electrolyzers 535 may comprise any now known or as yet unknown electrolysis devices. For example, electrolyzer 535 may again comprise designs, methods and systems such as those disclosed in U.S. patent application Ser. No. 17/820,222 filed Aug. 16, 2022 and entitled “Electrolyzer Systems and Methods.”

In accordance with the present disclosure, devices, systems and methods for improved hydrogen or oxyhydrogen manufacture may comprise two or more distributed electrolyzer stacks 535.

Again, because of the power generated by the solar generators may vary based on factors such as weather, time of day or year, and other factors, an electrolyzer stack in accordance with the present disclosure may have an aggregate resistance (R) adjusted to match the maximum power point of the DC power source (i.e., the solar generator) through one or more mechanisms, including but not limited to changing or adjusting:
the depth of one or both of the negative or positive electrodes in the electrolytic fluid;
the fluid level (e.g., the fluid height relative to one or more electrodes);
the fluid temperature;
the distance between the positive and negative electrodes;
the number of electrode cells in series;
the number of electrode panels in parallel;
the fluid volume;
the surface area of the electrodes exposed to the electrolyte; and
the stack resistance using other methods, now known or as yet unknown.
   In one embodiment, the resistance is changed automatically by a controller (or control system) based on changes in the input voltage.

With continuing reference to FIG. 6, in accordance with the present disclosure, an oxyhydrogen boiler 550 uses the oxyhydrogen produced by the electrolyzers 535 as fuel to generate steam in the boiler 550 to generate electrical power, for example to a factory 560 or other facility capable of using steam generated electrical power, heating or the like.

### DEFINITIONS (FOR PURPOSES OF THIS DISCLOSURE)

Generally, an industrial process is any process that uses heat at a rate equivalent to greater than 2000, 5000, 10,000, 15,000, 20,000, 40,000, 80,000, 160,000, or 320,000 pounds of steam per hour, depending on the embodiment. Industrial heat refers to many methods by which heat is used to transform materials into valuable products. For example, heat is used to remove moisture, separate chemicals, create steam, treat metals, melt plastics, Agricultural space and media heating, cooking, pressurization, sterilization, and bleaching, industrial distillation, concentrating, drying, or kilning, and chemical or other high-temperature processes, silicon and other refining, including semiconductor production, and much more. Depending upon the process involved, industrial heat can be broken down into low-, medium-, and high-temperature heat. For instance, cement kilns require high temperatures, while drying or washing applications in the food industry operate at lower temperatures. Various practical processes and devices include but are not limited to drying, primary steam reforming, steam, steeping, drying, combustion gases, heating kilns, calciners, crystallizers, dryers, stock preparation, wood digesting, bleaching, evaporation, chemical preparation, primary reforming, methanol distillation, byproduct drying (corn dry mills pretreatment and conditioning, lignocellulosic processes), and furnaces such as cracking furnaces.

Process steam is the steam system in a facility that transfers process heat throughout the facility.

For purposes of this disclosure, a hydrogen boiler is any boiler that has been specifically modified to use hydrogen as combustion fuel. For purposes of this disclosure, a hydrox boiler is any boiler that has been specifically modified to use a mixture of hydrogen and oxygen (such as hydrox) as the reactants in a boiler. In some embodiments, this definition includes a modified condensing boiler. In these or other embodiments, the mixture of hydrogen and oxygen is generated locally to the boiler by electrolysis and not separated before delivery to the boiler. In other embodiments, the mixture is prepared before entry into the boiler. In these or other embodiments, the mixture is prepared simultaneously with entry into the boiler or prepared shortly after entry into the boiler.

In some implementations, “Flat on ground (FOG)” refers to a group of greater than 50, 100, 200, 400, 600, 800, 1000, or 1500 modules in which at least 80 percent of the modules have at least one contact point, as defined below, that rests on the ground or rests on a contact surface of one or more structures, provided that the portion or portions of the structure or structures encompassed by the volume of space beneath and perpendicular to the contact surface is solid or constrains air movement. In some implementations, “FOG” means any flat mounting substantially parallel to the earth or ground that places the plane of the array within a short distance above the ground. This disclosure sometimes uses “ground-mounted” as a synonym for “FOG”. In some versions, “flat” means horizontally flat and substantially parallel to the earth. In some implementations, a “ground module” is a FOG module.

In some implementations, “ground level” is the level of the ground immediately before module installation.

Having thus described some embodiments of the invention, other variations and embodiments that do not depart from the spirit of the invention will become apparent to those skilled in the art. The scope of the present invention is thus not limited to any particular embodiment but is instead in the appended claims and the legal equivalents thereof. Unless stated in the written description or claims, the steps of any method recited in the claims may be performed in any order capable of yielding the desired result. No language in the specification should be construed as indicating that any non-claimed limitation is included in a claim. The terms “a” and “an” used in the context of describing the invention (especially in these claims) are to be construed to cover both the singular and the plural unless otherwise indicated or contradicted by context.

What is claimed is:

1. A system for manufacturing hydrogen gas using electrolysis comprising:
a solar power generator;
an electrolyzer powered by the solar power generator;
a gas separator; and
a gas compressor.

2. The system for manufacturing hydrogen gas using electrolysis of claim 1, wherein the solar power generator is at least one PV assembly.

3. The system for manufacturing hydrogen gas using electrolysis of claim 1, wherein the solar power generator is at least one PV array.

4. The system for manufacturing hydrogen gas using electrolysis of claim 1, wherein the solar power generator is at least one earth mount PV assembly.

5. The system for manufacturing hydrogen gas using electrolysis of claim 2, comprising at least two PV assemblies connected in at least one of in parallel or in series.

6. The system for manufacturing hydrogen gas using electrolysis of claim 1, wherein the electrolyzer comprises at least two distributed electrolyzer stacks.

7. The system for manufacturing hydrogen gas using electrolysis of claim 1, further comprising a gas transport.

8. The system for manufacturing hydrogen gas using electrolysis of claim 7, wherein the gas transport is a vehicle.

9. The system for manufacturing hydrogen gas using electrolysis of claim 7, wherein the gas transport is a pipeline.

10. The system for manufacturing hydrogen gas using electrolysis of claim 1, further comprising a control system.

11. A system for manufacturing oxyhydrogen gas using electrolysis comprising:
a solar power generator;
an oxyhydrogen electrolyzer powered by the solar power generator; and
an oxyhydrogen boiler that generates steam for generating electrical power.

12. The system for manufacturing oxyhydrogen gas using electrolysis of claim 11, wherein the electrolyzer comprises at least two distributed oxyhydrogen electrolyzer stacks.

13. The system for manufacturing oxyhydrogen gas using electrolysis of claim 11, further comprising a control system.
